(19) United States
(12) Patent Application Publication
(10) Pub. No.: US 2007/0198811 A1
(43) Pub. Date: Aug. 23, 2007

(54) Data-driven information processor performing operations between data sets included in data packet

(75) Inventor: Shinichi Yoshida, Nara-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi (JP)

(21) Appl. No.: 11/648,794

(22) Filed: Jan. 3, 2007

(30) Foreign Application Priority Data
Jan. 4, 2006 (JP) 2006-000197

(51) Int. Cl. G06F 15/00

(52) U.S. Cl. 712/26

(57) ABSTRACT

A data pair detector queues data to be paired, generates a data packet including the data to be paired, and outputs the data packet. An operation unit selects the data which are subject to an operation from a first data set included in the data packet outputted from the data pair detector based on a second data set, then performs the operation between the selected data. A program storage unit generates-a data packet by adding destination information and instruction information to an operation result of the operation unit and outputs the generated data packet. Accordingly, various operations can be performed, thereby improving processing efficiency and reducing a program memory capacity required.

This nonprovisional application is based on Japanese Patent Application No. 2006-000197 filed with the Japan Patent Office on Jan. 4, 2006, the entire contents of which are hereby incorporated by reference.

### BACKGROUND OF THE INVENTION

1. Field of the Invention

The present invention relates to a data-driven information processor capable of constructing a multiprocessor system by interconnecting input-output ports and, more particularly, to a data-driven information processor performing high-speed processing of image data or the like from video signals.

2. Description of the Background Art

In recent years, in various fields requiring high-speed processing of a large amount of data such as multimedia processing or high definition image processing, there is an increasing demand for improvement in processor performance. However, the present LSI (Large Scale Integrated circuit) manufacturing technique has a limit to its ability to speed up the device. For this reason, parallel processing has drawn attention and been extensively studied and developed.

Among computer architectures suitable for parallel processing, data-driven architecture is especially drawing attention. In a data-driven processing method, processes are performed in parallel according to the following rule: “A process is performed when all input data necessary for the process are ready and resources such as an operation unit necessary for the process are allocated”.

FIGS. 1A and 1B show a schematic configuration of a conventional data-driven information processor and an example of a data packet configuration. As shown in FIG. 1A, this conventional data-driven information processor includes a merging unit (J) 211, a data pair detector (FC) 212, an operation unit (FP) 213, a program storage unit (PS) 214, and a branch unit (B) 215, all of which are connected with a circulation pipeline.

As shown in FIG. 1B, the data packet used in this conventional data-driven information processor includes an instruction information 216, a destination information (node number) 217, a generation number 218, and a data section 219. In the data packet, the data section 219 includes only one piece of data 1.

Instruction information 216 indicates what kind of operation is applied to data section 219. Destination information 217 indicates which part of a program the data fetches and corresponds to the node number in the program. Generation number 218 is information to identify a plurality of pieces of data having a same destination.

Merging unit 211 arbitrates between the data packets from an input port and from branch unit 215, rearranges these data packets in a predetermined order, and outputs them to data pair detector 212.

Receiving the data packets from merging unit 211, data pair detector 212 queues two data packets which are subject to an operation, and as soon as these two packets are received, outputs them to operation unit 213. Data packets that do not need to be queued are outputted as they are from data pair detector 212.

Operation unit 213 executes arithmetic operations such as addition and multiplication, and logical operations on the data included in the data packet received from data pair detector 212 in accordance with an operation instruction included in the data packet. Operation unit 213 then stores an operation result in the data packet and outputs the data packet to program storage unit 214.

Program storage unit 214 adds a next operation instruction and destination information (node number) of the program to the data packet received from operation unit 213. Program storage unit 214 thus generates a data packet composed of predetermined bit fields and outputs it to branch unit 215.

Branch unit 215 refers to the destination information of the data packet outputted from program storage unit 214 and determines whether the data packet should be processed in its own processor or not. Determining that the data packet should be processed in its own processor, branch unit 215 outputs the data packet to merging unit 211. On the other hand, determining that the data packet should be processed in another processor, branch unit 215 outputs the data packet outside the processor.

A related art of such a data-driven information processor is the invention disclosed in Japanese Patent Laying-Open No. 09-114664 (hereinafter, patent document 1).

FIGS. 2A-2C show a schematic configuration of a data-driven information processor disclosed in patent document 1 and examples of a data packet configuration. As shown in FIG. 2A, the data-driven information processor includes an input controller 210 in addition to the configuration shown in FIG. 1A. Input controller 210 receives a plurality of pieces of data independent from each other from input ports 1 to N and accommodates them in a single data packet.

FIG. 2B shows an example of a data packet generated by input controller 210 and including the plurality of data. In this data packet, data section 219 includes N pieces of data received from ports 1 to N so that the plurality of data share a single piece of instruction information 216 and other information.

One example of data 1 to N is N data having successive generation numbers and sharing the same instruction information 216 and the same destination information 217. In this case, generation number 218 is, for example, the generation number of data 1. The generation numbers of data 2 to N can be restored from generation number 218 based on the storage position of each data.

FIG. 2C shows an example of the data packet after the queuing is performed by data pair detector 212. This data packet includes two data sets 220 and 221. First data set 220 includes data A₁ to A_{N} and second data set 221 includes data B₁ to B_{N}.

Operation unit 213 performs the operation of data A₁ to A_{N} of first data set 220 and data B₁ to B_{N} of second data set 221 in parallel. This can reduce data redundancy, thereby improving processing efficiency.

The data-driven information processor disclosed in patent document 1, which can process a data packet having a plurality of pieces of data, cannot perform operations between the data in a single data set.

On the other hand, Japanese Patent Laying-Open No. 2001-256214 (hereinafter, patent document 2) discloses a data-driven information processor which supports a reorder instruction to rearrange a plurality of pieces of data in a data packet.

FIG. 3 shows an operation unit disclosed in patent document 2 for executing the reorder instruction. The operation unit includes four multiplexers (hereinafter, MUXs) 231 to 234.

MUX 231 selects one of data A0 to A3 in first data set 220 in accordance with data b0 in second data set 221 and outputs the result as data C0 of third data set 222. MUX 232 selects one of data A0 to A3 in first data set 220 in accordance with data B1 in second data set 221 and outputs the result as data C1 of third data set 222. MUX 233 selects one of data A0 to A3 in first data set 220 in accordance with data B2 in second data set 221 and outputs the result as data C2 of third data set 222. MUX 234 selects one of data A0 to A3 in first data set 220 in accordance with data B3 in second data set 221 and outputs the result as data C3 of third data set 222.

FIG. 4 shows an example of an operation using the reorder instruction. When (3,2,0,1) is set in (b0, B1, B2, B3) as second data set 221, executing the reorder instruction causes (A0, A1, A2, A3) in first data set 220 to be rearranged into (A3, A2, A0, A1) and to be outputted as third data set 222.

FIG. 5 shows a smoothing filter process with respect to three pixels in data sets. In FIG. 5, the smoothing filter process is performed using first data set 220 and second data set 223, and (A0+A1+A2, A1+A2+A3, A2+A3+A4, A3+A4+A5) is outputted as third data set (C0, C1, C2, C3).

FIG. 6 shows an example of a program description of the smoothing filter process shown in FIG. 5. A reorder instruction 301 rearranges first data set 220 into (A1, A2, A3, A0). Then, a mul instruction 302 multiplies unnecessary data by zero to generate (A1, A2, A3, 0). Then, as the operation result of an add instruction 303, (A0+A1, A1+A2, A2+A3, A3) is outputted.

A reorder instruction 304 rearranges the data set outputted from mul instruction 302 into (A2, A3, 0, 0). Then, as the operation result of an add instruction 305, (A0+A1+A2, A1+A2+A3, A2+A3, A3) is outputted.

On the other hand, a reorder instruction 306 rearranges second data set 223 into (A4, A4, A4, A5). Then, a mul instruction 307 multiplies unnecessary data by zero to generate (0, 0, A4, A5). Furthermore, a reorder instruction 308 rearranges the data set outputted from mul instruction 307 into (0, 0, 0, A4). Then, as the operation result of an add instruction 309, (0, 0, A4, A4+A5) is output. Then, as the operation result of an add instruction 310, (A0+A1+A2, A1+A2+A3, A2+A3+A4, A3+A4+A5) is outputted.

The smoothing filter process can be thus performed by repeating the reorder instructions, the mul instructions, and the add instructions. However, the process requires as many as ten instructions, causing a decrease in processing efficiency and an increase in program memory capacity required.

### SUMMARY OF THE INVENTION

An object of the present invention is to provide a data-driven information processor capable of high-speed processing.

Another object of the present invention is to provide a data-driven information processor capable of reducing program memory capacity.

The data-driven information processor of an aspect of the present invention includes a data pair detector for queuing data to be paired, and generating and outputting a data packet including the data to be paired; an operation unit for performing an operation on a plurality of data sets included in the data packet outputted from the data pair detector; and a program storage unit for generating a data packet by adding destination information and instruction information to the operation result of the operation unit and outputting the generated data packet, wherein the operation unit selects data which are subject to an operation from a first data set based on a second data set and performs the operation between the selected data. Accordingly, various operations can be performed, thereby improving processing efficiency. Also, the program memory capacity required can be reduced.

The operation unit preferably includes: a zero-value generator for generating zero-value data; a plurality of selectors for selectively outputting the respective data of the first data set and the zero-value data generated by the zero-value generator based on the respective data of the second data set; and an adder for adding the data outputted from the plurality of selectors together. Accordingly, the smoothing filter process and the like can be performed at high speed.

The operation unit preferably includes: a minimum-value generator for generating predetermined minimum-value data; a plurality of selectors for selectively outputting the respective data of the first data set and the minimum-value data generated by the minimum-value generator based on the respective data of the second data set; and a maximum-value calculator for calculating and outputting the maximum value from the data outputted from the plurality of selectors. Accordingly, the maximum value of specific data in the data set can be calculated.

The data-driven information processor of another aspect of the present invention includes: a data pair detector for queuing data to be paired, and generating and outputting a data packet including the data to be paired; an operation unit for performing an operation on a plurality of data sets included in the data packet outputted from the data pair detector; and a program storage unit for generating a data packet by adding destination information and instruction information to the operation result of the operation unit and outputting the generated data packet, wherein the operation unit qualifies and performs the operation with respect to the respective data of the first data set using corresponding data of the second data set. Accordingly, various operations can be performed depending on the way of providing the second data, thereby improving processing efficiency. Also, the program memory capacity required can be reduced.

The operation unit preferably includes: a plurality of multipliers each for multiplying the respective data of the first data set by the respective divided data obtained by dividing the data of the second data sets; and an adder for adding the multiplication results of the plurality of multipliers together. Accordingly, product-sum operations can be performed at high speed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A and 1B show a schematic configuration of a conventional data-driven information processor and an example of a data packet configuration;

FIGS. 2A-2C show a schematic configuration of a data-driven information processor disclosed in patent document 1 and examples of a data packet configuration;

FIG. 3 shows an operation unit for executing a reorder instruction disclosed in patent document 2;

FIG. 4 shows an example of an operation using the reorder instruction;

FIG. 5 shows a smoothing filter process with respect to three pixels in data sets;

FIG. 6 shows an example of a program description of the smoothing filter process shown in FIG. 5;

FIG. 7 is a block diagram showing a schematic configuration of a data-driven information processor of a first embodiment of the present invention;

FIG. 8 is a diagram showing operations in an operation unit 13 of the data-driven information processor according to the first embodiment of the present invention;

FIG. 9 shows a configuration example of operation unit 13 in the first embodiment of the present invention;

FIG. 10 is a diagram showing operations in operation unit 13 of the data-driven information processor according to a second embodiment of the present invention;

FIG. 11 shows a configuration example of operation unit 13 of the second embodiment of the present invention;

FIG. 12 shows an example of the program description in a case where the smoothing filter process is performed using operation unit 13 shown in FIG. 11;

FIG. 13 shows a configuration example of operation unit 13 of a third embodiment of the present invention;

FIG. 14 is a diagram showing operations in operation unit 13 of the data-driven information processor according to a fourth embodiment of the present invention; and

FIG. 15 shows a configuration example of operation unit 13 of the fourth embodiment of the present invention.

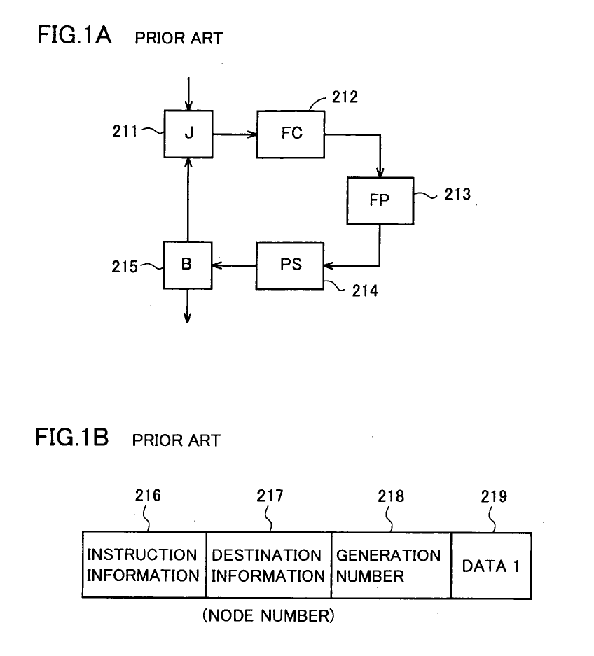

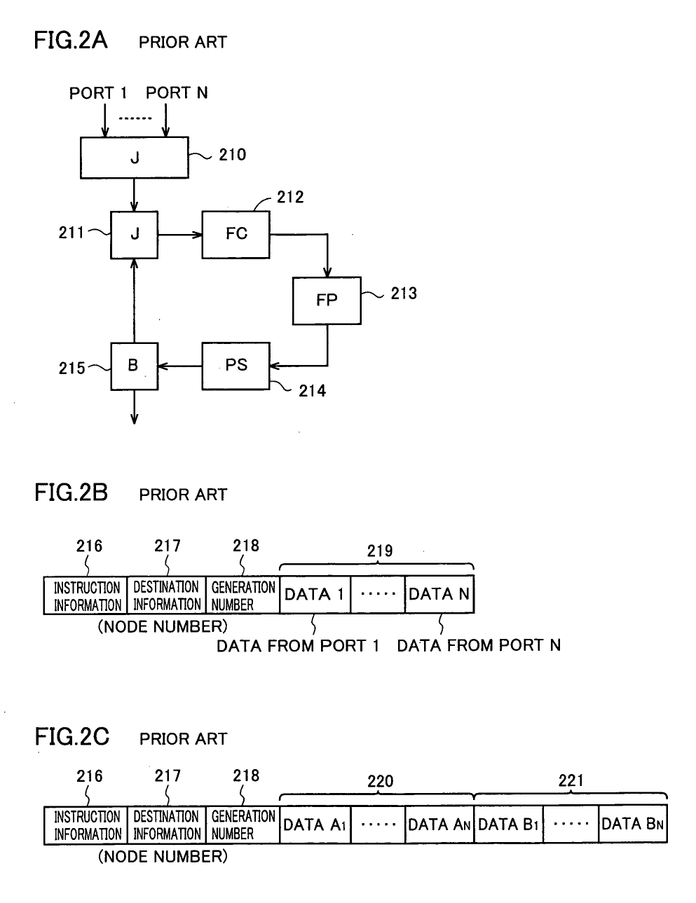

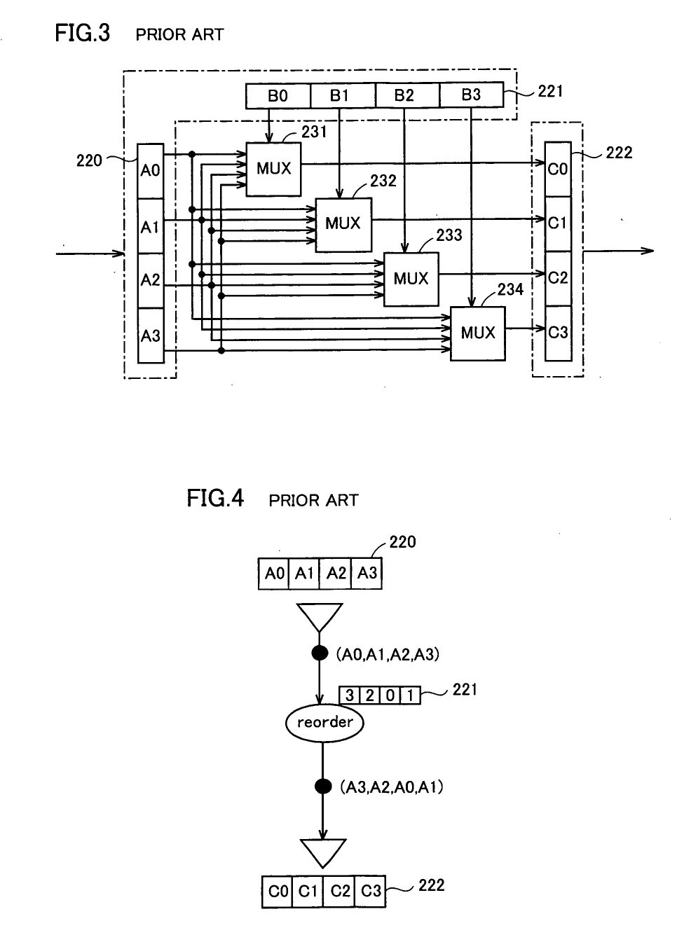

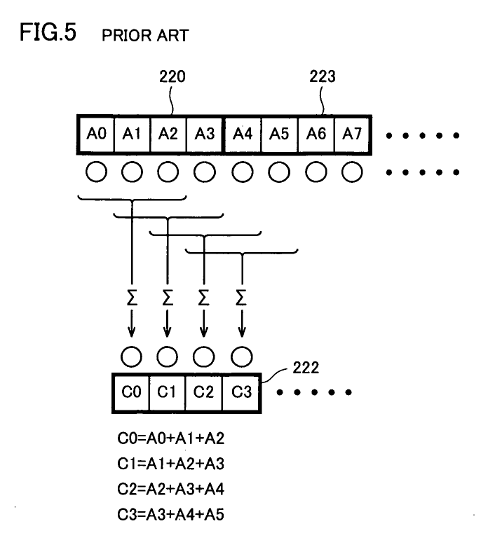

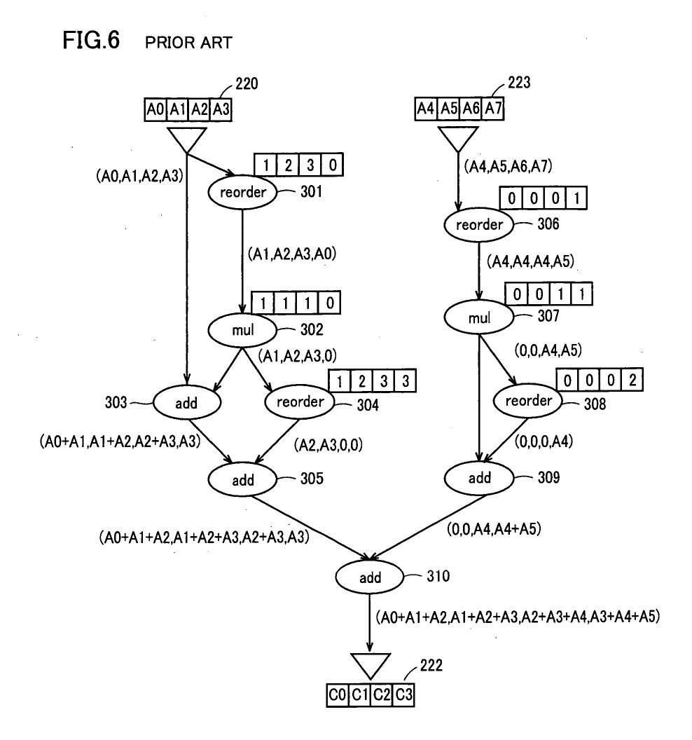

### DESCRIPTION OF THE PREFERRED EMBODIMENTS

### First Embodiment

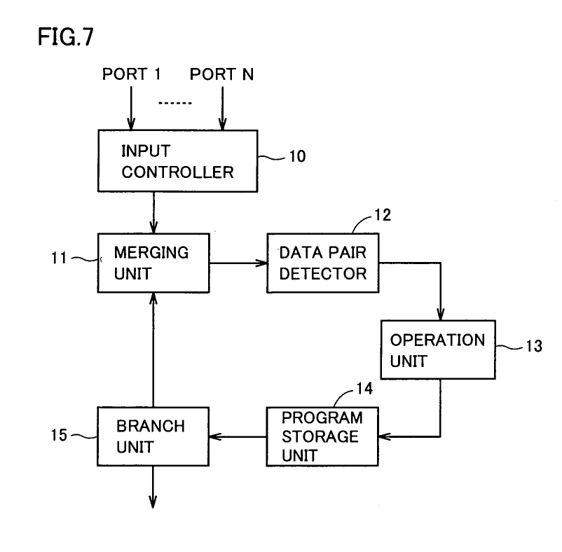

FIG. 7 is a block diagram showing a schematic configuration of a data-driven information processor according to the first embodiment of the present invention. The data-driven information processor includes an input controller 10, a merging unit 11, a data pair detector 12, an operation unit 13, a program storage unit 14, and a branch unit 15, all of which are connected to form a circulation pipeline.

Input controller 10 receives a plurality of pieces of data independent from each other from input ports 1 to N, accommodates them in a single data packet, and outputs the data packet to merging unit 11. Alternatively, merging unit 11 may be designed to receive a data packet including a plurality of pieces of data directly from outside without providing input controller 10.

Merging unit 11 arbitrates between data packets from input controller 10 and from branch unit 15, rearranges these data packets in a predetermined order, and outputs them to data pair detector 12.

Receiving the data packets from merging unit 11, data pair detector 12 queues two data packets which are subject to an operation, and as soon as these two packets are received, outputs them to operation unit 13. Data packets that do not need to be queued are outputted as they are from data pair detector 12.

Operation unit 13 executes arithmetic operations such as addition and multiplication, and logical operations on the data included in the data packet received from data pair detector 12 in accordance with the operation instruction included in the data packet. Operation unit 13 then stores the operation result in the data packet and outputs the data packet in the program storage unit 14.

Program storage unit 14 adds the next calculation instruction and destination information (node number) of the program to the data packet received from operation unit 13. Program storage unit 14 thus generates a data packet composed of predetermined bit fields and outputs it to branch unit 15.

Branch unit 15 refers to the destination information of the data packet outputted from program storage unit 14 and determines whether the data packet should be processed in its own processor or not. Determining that the data packet should be processed in its own processor, branch unit 15 outputs the data packet to merging unit 11. On the other hand, determining that the data packet should be processed in another processor, branch unit 15 outputs the data packet outside the processor.

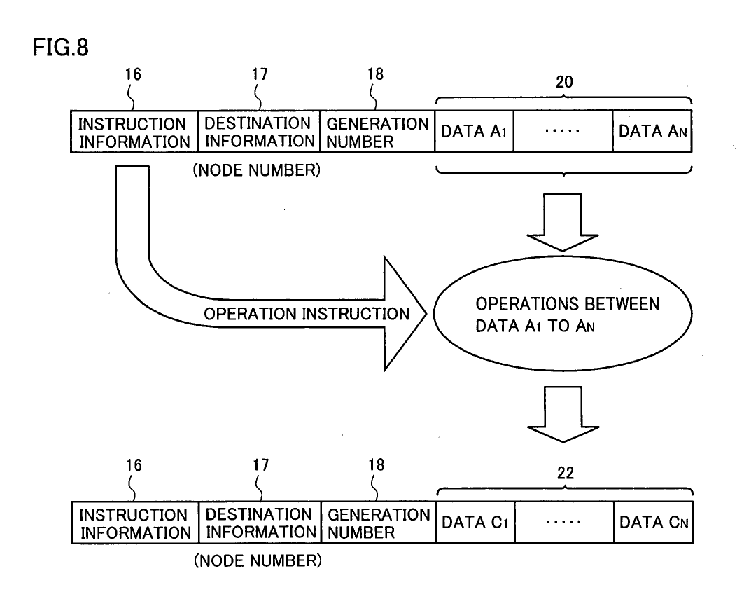

FIG. 8 is a diagram showing operations in operation unit 13 of the data-driven information processor according to the first embodiment of the present invention. In FIG. 8, only first data set 20 is effective, and no queuing is performed in data pair detector 12.

A data packet shown in FIG. 8 includes an instruction information 16, a destination information (node number) 17, a generation number 18, and a first data set 20. Data set 20 includes N-bit data A₁ to A_{N}. Operation unit 13 performs operations between data A₁ to A_{N} included in first data set 20 according to instruction information 16, and stores operation results C₁ to C_{N} in data set 22 of the output data packet.

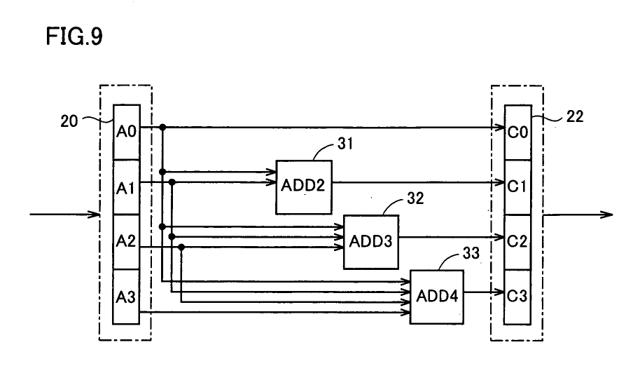

FIG. 9 shows a configuration example of operation unit 13 in the first embodiment of the present invention. Operation unit 13 includes a 2-input adder ADD2 (31) for adding two pieces of data together; a 3-input adder ADD3 (32) for adding three pieces of data together; and a 4-input adder ADD4 (33) for adding four pieces of data together. Operation unit 13 outputs the operation result (A0, A0+A1, A0+A1+A2, A0+A1+A2+A3) as data set 22. Note that operation unit 13 includes a plurality of other operation units corresponding to the types of operation instructions.

The configuration of operation unit 13 shown in FIG. 9 is just an example, and the operation units may be configured in any way as long as they perform operations between the plurality of pieces of data included in data set 20.

As described hereinbefore, the data-driven information processor of the present embodiment performs operations between the data included in the data set included in a data packet. This makes it unnecessary to queue pair data, thereby improving the processing efficiency of the data-driven information processor. Integrating operation circuits suitable for application into operation unit 13 can further improve the processing efficiency and reducing the program memory capacity required.

### Second Embodiment

The data-driven information processor according to the second embodiment of the present invention has nearly the same configuration as the data-driven information processor according to the first embodiment shown in FIG. 7. Therefore, the details of the same configuration and functions will not be repeated.

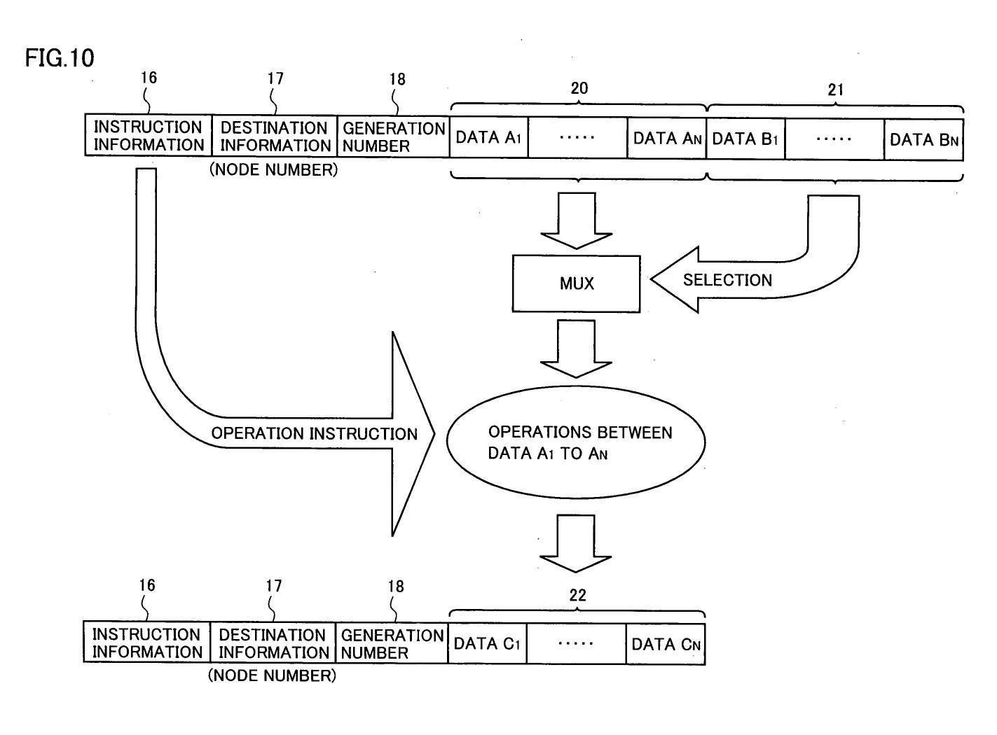

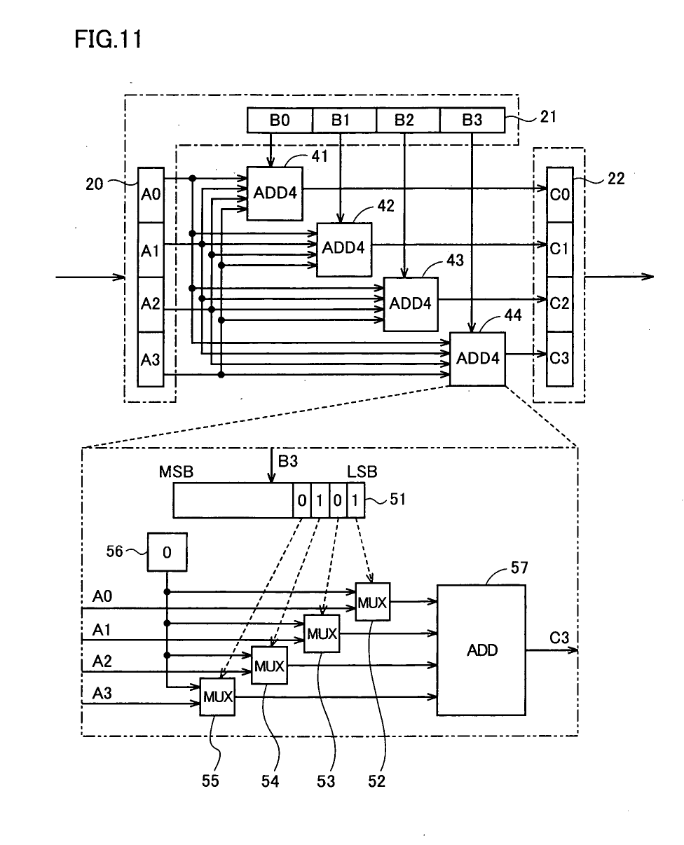

FIG. 10 is a diagram showing operations in operation unit 13 of the data-driven information processor according to the second embodiment of the present invention. In FIG. 10, first data set 20 and second data set 21 are both effective, and data pair detector has queued pair data.

In FIG. 10, the contents (data B₁ to B_{N}) of second data set 21 are selectively inputted to the multiplexer (MUX), and the MUX selects an operation target from the contents (data A₁ to A_{N}) of first data set 20. Operation unit 13 performs operations between the data outputted from the MUX according to instruction information 16 and stores operation results C₁ to C_{N} in data set 22 of the output data packet.

FIG. 11 shows a configuration example of operation unit 13 according to the second embodiment of the present invention. Operation unit 13 includes 4-input adders ADD4 (41-44) each for adding four pieces of data together. Each of ADD4 (41-44) receives first data set 20 (A0-A3) and performs operations on the four pieces of data in accordance with data b0 to B3 in second data set 21.

Since ADD4 (41-44) have the same internal configuration, ADD4 (44) is taken up as an example. ADD4 (44) includes MUXs 52 to 55 for selecting data according to each bit of data B3 (51), a zero-value generator 56 for generating zero-value data, and a 4-input adder 57.

MUX 52 selects and outputs a value selected from zero-value generator 56 when bit 0 of data B3 (51) is “0”, and selects and outputs data A0 in first data set 20 when bit 0 of data B3 (51) is “1”.

MUX 53 selects and outputs a value from zero-value generator 56 when bit 1 of data B3 (51) is “0”, and selects and outputs data A1 in first data set 20 when bit 1 of data B3 (51) is “1”.

MUX 54 selects and outputs a value from zero-value generator 56 when bit 2 of data B3 (51) is “0”, and selects and outputs data A2 in first data set 20 when bit 2 of data B3 (51) is “1”.

MUX 55 selects and outputs a value selected from zero-value generator 56 when bit 3 of data B3 (51) is “0”, and selects and outputs data A3 in first data set 20 when bit 3 of data B3 (51) is “1”.

ADD 57 adds the values outputted from MUXs 52 to 55 and outputs the addition result as data C3 of third data set 22. As shown in FIG. 11, when the lower 4 bits of data B3 are “0101”, adder 57 outputs “A0+A2” as data C3.

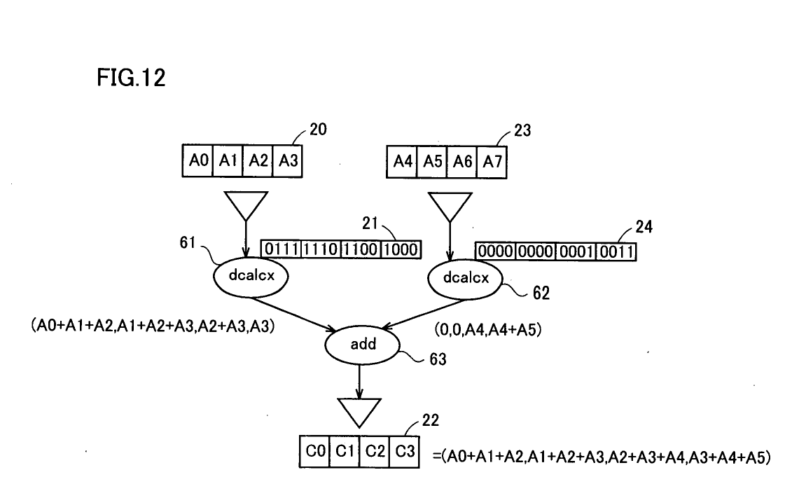

FIG. 12 shows an example of a program description in a case where a smoothing filter process is performed using operation unit 13 shown in FIG. 11. An instruction dcalcx is an instruction to make the operation circuit shown in FIG. 11 perform the operation.

An instruction dcalcx 61 produces an operation result (A0+A1+A2, A1+A2+A3, A2+A3, A3) from first data set 20. An instruction dcalcx 62 produces an operation result (0, 0, A4, A4+A5) from second data set 23. An add instruction 63 causes these operation results to be added together and then (A0+A1+A2, A1+A2+A3, A2+A3+A4, A3+A4+A5) to be outputted as data C0 to C3.

Thus, operation unit 13 enables the program of the smoothing filter process which conventionally requires ten instructions to be executed in only three instructions.

As described hereinbefore, in the data-driven information processor of the present embodiment, the contents (data B₁ to B_{N}) of second data set 21 are inputted to the MUXs as selection inputs, and the MUXs select the operation target from the contents (data A₁ to A_{N}) of first data set 20. As a result, the smoothing filter process can be performed at high speed so as to improve processing efficiency and to reduce the program memory capacity required.

### Third Embodiment

The data-driven information processor according to the third embodiment of the present invention has nearly the same configuration as the data-driven information processor according to the first embodiment shown in FIG. 7. Therefore, the details of the same configuration and functions will not be repeated. Operation unit 13 of the data-driven information processor according to the third embodiment of the present invention performs the same operation as the one described with FIG. 10.

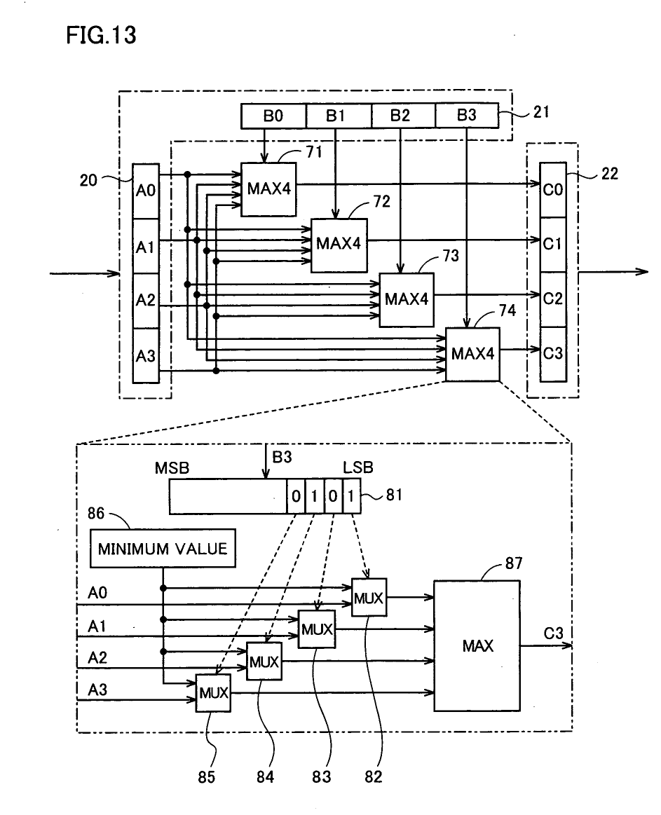

FIG. 13 shows a configuration example of operation unit 13 according to the third embodiment of the present invention. Operation unit 13 includes 4-input maximum-value calculators MAX4 (71-74) each for outputting the maximum value of four pieces of data. Each of MAX4 (71-74) receives first data set 20 (A0-A3) and performs an operation on the four pieces of data in accordance with data b0 to B3 in second data set 21.

Since MAX4 (71-74) have the same internal configuration, MAX4 (74) is taken up as an example. MAX4 (74) includes MUXs 82-85 each for selecting data according to each bit of data B3 (81), a minimum-value generator 86 for generating a minimum value that the data used in this system can be, and a 4-input maximum-value calculator 87.

MUX 82 selects and outputs a value from minimum-value generator 86 when bit 0 of data B3 (81) is “0”, and selects and outputs data A0 in first data set 20 when bit 0 of data B3 (81) is “1”.

MUX 83 selects and outputs a value from minimum-value generator 86 when bit 1 of data B3 (81) is “0”, and selects and outputs data A1 in first data set 20 when bit 1 of data B3 (81) is “1”.

MUX 84 selects and outputs a value from minimum-value generator 86 when bit 2 of data B3 (81) is “0”, and selects and outputs data A2 in first data set 20 when bit 2 of data B3 (81) is “1”.

MUX 85 selects and outputs a value from minimum-value generator 86 when bit 3 of data B3 (81) is “0”, and selects and outputs data A3 in first data set 20 when bit 3 of data B3 (81) is “1”.

MAX 87 calculates the maximum of the values outputted from MUXs 82 to 85 and outputs it as data C3 of third data set 22. As shown in FIG. 13, when the lower four bits of data B3 are “0101”, MAX 87 outputs max (A0, A2) as data C3.

As described hereinbefore, in the data-driven information processor of the present embodiment, the contents (data B₁ to B_{N}) of second data set 21 are inputted to the MUXs as selection inputs, and the MUXs select the operation target from the contents (data A₁ to A_{N}) of first data set 20. This makes it possible to improve processing efficiency and to reduce the program memory capacity required.

In the second and third embodiments of the present invention, the operations used are addition and maximum-value calculations. However, the operations can further include arithmetic operations other than addition such as subtraction and multiplication, comparison operations using other than a maximum value such as a minimum value, and logical operations such as logical-sum operation and logical-product operation.

### Fourth Embodiment

The data-driven information processor according to the fourth embodiment of the present invention has nearly the same configuration as the data-driven information processor according to the first embodiment shown in FIG. 7. Therefore, the details of the same configuration and functions will not be repeated.

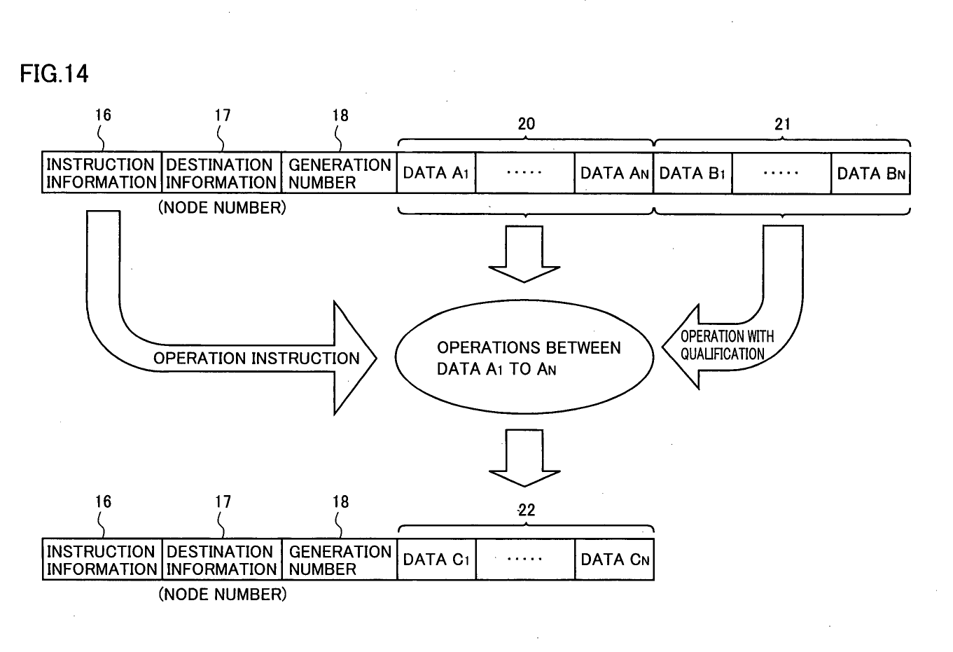

FIG. 14 is a diagram showing operations in operation unit 13 of the data-driven information processor according to the fourth embodiment of the present invention.

In FIG. 14, using the contents (data B₁ to B_{N}) in second data set 21 as a qualified operator, operations are performed with respects to the contents (data A₁ to A_{N}) of first data set 20. Operation unit 13 performs operations between data A₁ to A_{N} in first data set 20 according to instruction information 16 and stores operation results C₁ to C_{N} in data set 22 of the output data packet.

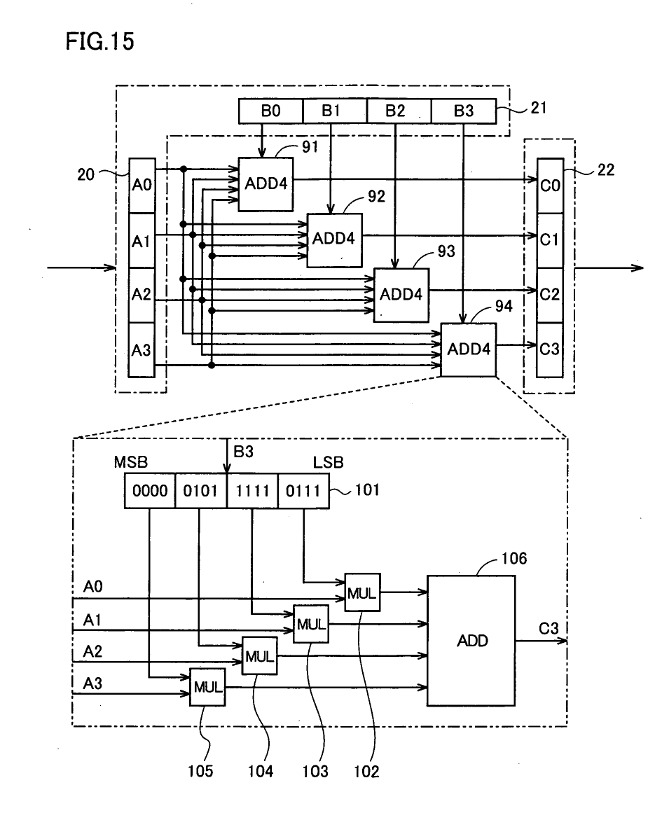

FIG. 15 shows a configuration example of operation unit 13 according to the fourth embodiment of the present invention. Operation unit 13 includes 4-input adders ADD4 (91-94) each for adding four pieces of data together. Each of ADD4 (91-94) receives first data set 20 (A0-A3) and performs operations on the four pieces of data in accordance with data B0 to B3 in second data set 21.

Since ADD4 (91-94) have the same internal configuration, ADD4 (94) is taken up as an example. ADD4 (94) includes multiplexers MULs 102 to 105 each for receiving four-divided data B3 (101), and a 4-input adder 106.

MUL 102 multiplies data A0 in first data set 20 by the lower four bits (bits 3 to 0) of data B3 (101) and outputs the multiplication result to ADD 106.

MUL 103 multiplies data A1 in first data set 20 by the next lower four bits (bits 7 to 4) of data B3 (101) and outputs the multiplication result to ADD 106.

MUL 104 multiplies data A2 in first data set 20 by the next lower four bits (bits 11 to 8) of data B3 (101) and outputs the multiplication result to ADD 106.

MUL 105 multiplies data A3 in first data set 20 by the upper four bits (bits 15 to 12) of data B3 (101) and outputs the multiplication result to ADD 106.

ADD 106 adds the values outputted from MULs 102 to 105 together and outputs the addition result as data C3 of third data set 22. As shown in FIG. 15, in a case where data B3 is “0000 0101 1111 0111”, when each of four-divided data B3 is a signed binary number, C3=(5×A2)−A1+(7×A0).

As described hereinbefore, in the data-driven information processor of the present embodiment, the contents of first data set 20 are qualified and operations are performed with respect to the qualified contents according to the contents of second data set 21. Therefore, various operations can be performed depending on the way of providing second data set 21, thereby improving processing efficiency.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data-driven information processor comprising:
a data pair detector for queuing data to be paired, and generating and outputting a data packet including the data to be paired;
an operation unit for performing an operation on a plurality of data sets included in the data packet outputted from said data pair detector; and
a program storage unit for generating a data packet by adding destination information and instruction information to an operation result of said operation unit and outputting the generated data packet, wherein
said operation unit selects data which are subject to the operation from a first data set based on a second data set and performs the operation between the selected data.

2. The data-driven information processor according to claim 1, wherein said operation unit includes:
a zero-value generator for generating zero-value data;
a plurality of selectors for selectively outputting respective data of said first data set and the zero-value data generated by said zero-value generator based on respective data of said second data set; and
an adder for adding the data outputted from the plurality of selectors together.

3. The data-driven information processor according to claim 1, wherein said operation unit includes:
a minimum-value generator for generating predetermined minimum-value data;
a plurality of selectors for selectively outputting respective data of said first data set and the minimum-value data generated by said minimum-value generator based on respective data of said second data set; and
a maximum-value calculator for calculating and outputting a maximum value from the data outputted from the plurality of selectors.

4. A data-driven information processor comprising:
a data pair detector for-queuing data to be paired, and generating and outputting a data packet including the data to be paired;
an operation unit for performing an operation on a plurality of data sets included in the data packet outputted from said data pair detector; and
a program storage unit for generating a data packet by adding destination information and instruction information to an operation result of said operation unit and outputting the generated data packet, wherein
said operation unit qualifies and performs the operation with respect to respective data of said first data set using corresponding data of said second data set.

5. The data-driven information processor according to claim 4, wherein said operation unit includes:
a plurality of multipliers each for multiplying the respective data of said first data set by respective divided data obtained by dividing the data of said second data set; and
an adder for adding multiplication results of said plurality of multipliers together.
